(19) United States
(12) Patent Application Publication
(10) Pub. No.: US 2009/0015023 A1
(43) Pub. Date: Jan. 15, 2009

(54) Method for Controlling a Drivetrain and Drivetrain

(75) Inventor: Marco Fleckner, Leonberg (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 12/172,010

(22) Filed: Jul. 11, 2008

(30) Foreign Application Priority Data
Jul. 13, 2007 (DE) 102007032726.0

(51) Int. Cl. H02P 9/04

(52) U.S. Cl. 290/40 C; 903/930

(57) ABSTRACT

A method for controlling a drivetrain for a road vehicle, in particular for a hybrid vehicle, is provided. The drivetrain includes at least an electric motor, an electric energy accumulator, and an active connection to at least one drivable axle. In the recuperation mode, thus, when an electric motor is operating as a generator for generating electric energy for charging an electric energy accumulator, the generated electric energy is transmitted at least partly to at least one electric heating resistor in order to convert the energy into heat.

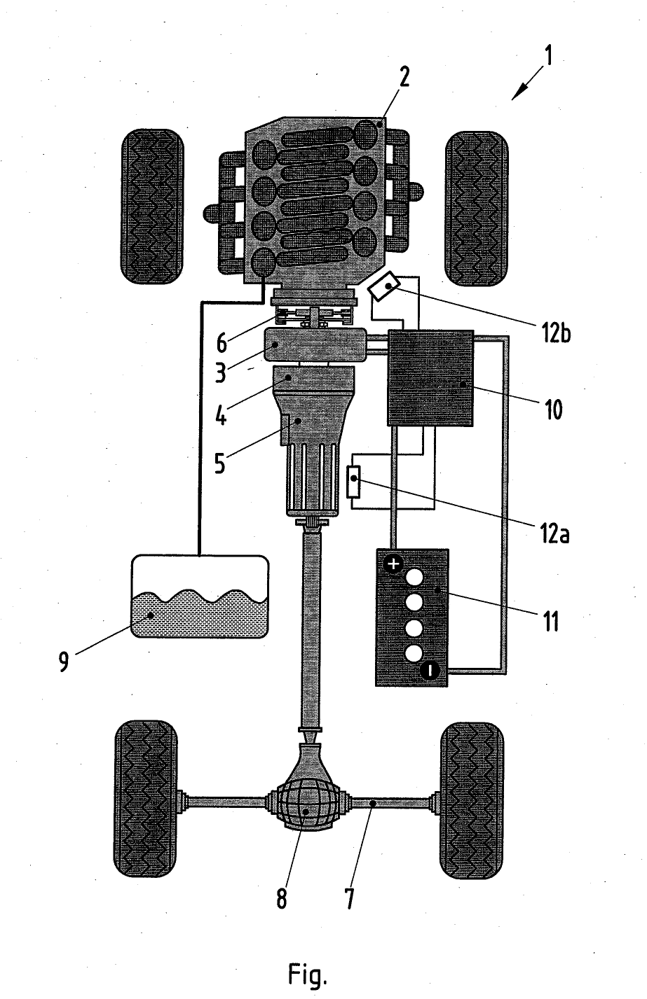

### CROSS-REFERENCE TO RELATED APPLICATION

This application claims the priority of German Application No. 10 2007 032 726.0, filed Jul. 13, 2007, the disclosure of which is expressly incorporated by reference herein.

### BACKGROUND AND SUMMARY OF THE INVENTION

The invention relates to a method for controlling a drivetrain, as well as a corresponding drivetrain, for a road vehicle, in particular a hybrid vehicle.

Hybrid vehicles usually have an internal combustion engine and at least one electric motor. The electric motor is typically provided as either a generator for charging an electric energy accumulator and/or as a motor for at least an additional drive of the hybrid vehicle. Frequently both are also provided, in that at certain times the electric energy accumulator is charged, and then at other times this electric energy accumulator is used for the electric drive of the hybrid vehicle.

A hybrid vehicle has the advantage over conventional vehicles having an internal combustion engine in that the kinetic energy may be largely recovered (recuperation). To this end, a torque is passed from at least one drivable axle of the hybrid vehicle to the electric motor. The recovered (recuperated) energy is buffered in the vehicle-sided electric energy accumulator, for example, a vehicle battery. As a function of the degree to which the electric motor is used as a generator, the electric motor, which is run as the generator, exerts a decelerating torque (generator torque) on the hybrid vehicle. A recuperation may occur in the passive overrun mode and during active braking. The overrun mode is a state, in which the vehicle is not actively driven, but rather is driven forward only by means of its own inertial mass, during which a variety of driving resistances and, optionally, a generator torque decelerate the vehicle. When braking, the driver actively decelerates the vehicle with the use of the generator torque and/or the service brake.

In the case of hybrid vehicles, the supply of fuel and the ignition are usually suspended during the recuperation mode. In addition, other precautionary measures are initiated to prevent engine braking of the internal combustion engine and, thus, to allow the kinetic energy to pass as completely as possible to the electric motor, which is operated as the generator. Thus, for example, the internal combustion engine may be mechanically disengaged by use of a corresponding disengagable clutch.

However, there is a problem in that when the electric energy accumulator is filled or for other reasons—such as overshooting the temperature limit values—, it cannot absorb any more electric energy. In this case, the electric motor can no longer be driven as a generator, because the dissipated electric energy can no longer be absorbed by the electric accumulator. Therefore, on braking and/or in overrun mode the electric motor can no longer be used to decelerate the vehicle. The result is that during the recuperation mode the driver experiences what he perceives to be (owing to its unfamiliarity) an unpleasant deceleration behavior of the hybrid vehicle.

The object of the invention is to provide an improved method for controlling a drivetrain of a hybrid vehicle. In the recuperation mode, in particular independently of the amount of electric energy stored in the electric energy accumulator, this method ensures that the deceleration behavior of the hybrid vehicle shall always remain constant. Another object of the invention is to provide a corresponding drivetrain.

The invention provides that in the recuperation mode (thus, when an electric motor, which is included in a drivetrain for a road vehicle, is operating as a generator for generating electric energy for charging an electric energy accumulator), the generated electric energy is transmitted at least partly to at least one electric heating resistor in order to convert the electric energy into heat. In other words, the electric energy that is generated by the generator is no longer transmitted in its entirety into the electric energy accumulator and/or the vehicle electrical system, but rather is “destroyed” in a heating resistor. Given a suitable design and/or arrangement, the result is the possibility of always taking a desired amount of the electric energy that has accumulated during the recuperation mode. Therefore, the amount of electric energy that is generated by the generator and, thus, also the generator torque, are designed independently of the intake capacity of the electric energy accumulator and/or consumption of the vehicle electrical system. As a result, therefore, a generator torque and, thus, a deceleration behavior of the vehicle can be realized that is especially independent of the charge state of the electric energy accumulator.

It is especially preferred that the generated electric energy is then transmitted to an electric heating resistor, when the electric energy accumulator can no longer store, wholly or partly, the electric energy that was generated in the recuperation mode. If the amount of electric energy that is generated by the generator and that is not needed to supply the vehicle electrical system can no longer be stored in the electric energy accumulator, this amount and, thus, also the generator torque would have to be reduced. However, at the same time the deceleration behavior of the vehicle would change during the recuperation mode. Therefore, the amount of electric energy that is generated by the generator and which is neither needed for supplying the vehicle electrical system nor can be stored in the electric energy accumulator, is passed to the electric heating resistor(s). If at all times the amount of electric energy that is generated by the generator and that cannot be stored in the electric energy accumulator is passed to the electric heating resistor(s), then a desired generator torque, which remains, in particular, constant, and thus, a deceleration behavior of the vehicle can be realized.

The invention can be installed in road vehicles with at least one electric motor, such as an electric vehicle. Preferably, however, the invention is installed in a hybrid vehicle, in particular in a parallel hybrid. In this case, the hybrid vehicle contains preferably an electric motor, which is arranged in the drivetrain between the internal combustion engine and the transmission. In this design, it is especially advantageous to provide the torque of the electric motor, which is operated as a generator, independently of the intake capacity of the electric energy accumulator. In this construction, the electric motor is usually adequately dimensioned in order to target a correspondingly unpleasant effect during the deceleration behavior if the electric energy that is generated by the generator can no longer be output in its entirety into the electric energy accumulator and/or the vehicle electrical system. On the other hand, it enables a relatively simple operation, since only one electric motor has to be observed that to this end is provided in the drivetrain itself.

In a preferred embodiment there are a plurality of electric heating resistors, in particular such resistors that exhibit different and/or controllable resistance values, and/or at different positions in the vehicle. As a result, there is a flexible possibility of converting electric energy that has accumulated in the recuperation mode into heat. In particular, prioritization can be provided in that an amount of energy that has accumulated in the recuperation mode and that is inadequate for operating all of the heating resistors, is distributed, according to a specified plan, to the various heating resistors.

It is especially preferred that the electric heating resistors are positioned in the area of the engine and/or the transmission components. In particular, the transmission components may be, for example, the differential, transfer case or main gearbox. The targeted heating of these components results in an increase in efficiency and, thus, a lower consumption of fuel, in particular, at a cold start. Hence, the electric energy that is generated in the recuperation mode and that cannot be stored in the electric energy accumulator is not simply “destroyed,” but rather is utilized in a targeted manner. Therefore, the result is not only the constant deceleration mode of the vehicle in the recuperation mode, but also an additional advantage.

It is also advantageous to provide electric heating resistors in the area of the battery. Modern high power batteries need a very precise temperature control that can be easily implemented in this way. Other advantageous possibilities consist of heating the interior of the motor vehicle, in particular by means of the air supply systems, and/or heating the vehicle catalytic converter, in order to show good exhaust gas behavior. Furthermore, water may be heated, for example, for the cooling or window cleaning water.

In order to monitor the temperature in the area of one electric heating resistor or a plurality of electric heating resistors, temperature sensors may be provided. For example, it may be provided that upon exceeding a limit value for the temperature, no more electric energy that is generated in the recuperation mode is to be transmitted to this electric heating resistor.

According to a second aspect of the invention, at least one electrically operated cooling component, in particular a Peltier element, is provided for converting the electric energy that is generated in the recuperation mode into the cold state. This, too, constitutes an efficient possibility for not just simply “destroying” the excess electric energy, but rather of utilizing it in a targeted manner. Such cooling components may be disposed, in particular, in the area of the vehicle battery in order to ensure an optimal temperature range of modern high power batteries. Furthermore, they may be provided for cooling the interior of the motor vehicle, in particular by way of the air supply systems. In this case, one such cooling component or a plurality of such cooling components may be provided in addition or as an alternative to the electric heating resistor(s). In the extreme case, the invention can also be realized only with the use of one electrically operated cooling component.

The inventive method is realized preferably as a control unit in a hybrid vehicle, as a modification of one or more existing control units, or as a separate control unit, such as in a hybrid manager. Then, the data exchange can be easily implemented by way of the vehicle-side network, for example, a controller area network (CAN).

Other objects, advantages and novel features of the present invention will become apparent from the following detailed description when considered in conjunction with the accompanying drawing.

### BRIEF DESCRIPTION OF THE DRAWING

The FIGURE depicts a drivetrain for a hybrid vehicle according to the invention.

### DETAILED DESCRIPTION OF THE DRAWING

Depicted in the FIGURE is a drivetrain 1, which is intended for a hybrid vehicle and which includes an internal combustion engine 2, an electric motor 3, and a transmission 5, which is coupled by way of a converter 4. Between the internal combustion engine 2 and the electric motor 3, a clutch 6 is provided. The output of the transmission 5 is effectively connected to a drivable axle 7 of the hybrid vehicle. To this end, the transmission 5 is connected to a shaft with a differential 8 in order to drive the axle 7. The internal combustion engine has a fuel supply 9. The electric motor 3 is connected to power electronics 10, which is designed as a control unit. The power electronics control, for example, a drive and/or recuperation phase, that is, the operation of the electric motor 3 as a motor and/or as a generator. Furthermore, the power electronics 10 are connected to an electric energy accumulator in the form of a vehicle battery 11 and to the electric heating resistors 12a and 12b, which are assigned to the transmission 5 and/or to the internal combustion engine 2.

In this case, the invention provides that in the recuperation mode (that is, when the electric motor 5 is operating as a generator in order to generate the electric energy, and when the internal combustion engine 2 may or may not be turned off), the generated electric energy is transmitted from the power electronics 10 to the battery 11 and/or to the electric heating resistors 12a, 12b. Then, the vehicle electrical system of the hybrid vehicle is supplied with the requisite amount of generated electric energy. Then, it is checked whether the battery 11 has an adequately sufficient charge state. If this is not the case, then a suitable amount of electric energy is transmitted to the battery 11 in order to charge the battery. When the battery 11 is charged up and, thus, no more electric energy is needed or when the electric motor 5, which is operated as the generator, produces more electric energy than the battery 11 needs, then this state is detected by the power electronics 10. In this case, the excess electric energy is transmitted to the electric heating resistors 12a and/or 12b in order to heat the transmission oil, the motor oil, and/or coolant.

In this case, the internal combustion engine 2 and/or the transmission 5 is/are also assigned temperature sensors, which measure the temperature of the respective transmission oil and/or motor oil and report back to the power electronics 10. In the case that neither the internal combustion engine 2 nor the transmission 5 exceeds its respective temperature limit value, a prioritization is executed such that the excess amount of electric energy below a limit value is transmitted to the electric heating resistor 12b in order to heat the internal combustion engine 2. If the amount of excess electric energy exceeds this limit value, the overshooting amount of excess electric energy is transmitted to the electric heating resistor 12a in order to heat the transmission 5. If the internal combustion engine 2 and/or the transmission 5 exceed(s) a respective temperature limit value, it may be provided that no more excess electric energy is transmitted to the respective electric heating resistor 12a and/or 12b. In addition, it may be provided that the control unit 10 no longer provides the respectively assigned heating resistors 12a and/or 12b with electric energy, if the corresponding maximum temperature values at the internal combustion engine 2 and/or at the transmission 5 are exceeded. As an alternative, the cooling system of the hybrid vehicle may be used in order to dissipate the additional heat that is accumulated owing to the electric heating elements 12a, 12b. Then, a corresponding temperature measurement and temperature control may be dispensed with; and only a prioritization may be carried out.

In summary, the result is a constant deceleration behavior of the hybrid vehicle in the recuperation mode, independently of the charge state of the battery 11. This leads to a driving experience that is comfortable for the driver, since the generator torque no longer varies and, thus, the deceleration behavior of the hybrid vehicle remains the same. The power electronics 10 always ensure that the electric energy, which is delivered by the electric motor 5, which is operated as a generator, is fed either into the battery 11 or into the electric heating resistors 12a and/or 12b. Thus, there is always also an intake of the amount of electric energy that is delivered by the electric motor 5 that is operated as a generator.

The foregoing disclosure has been set forth merely to illustrate one or more embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling a drivetrain of a hybrid vehicle, the drivetrain including at least an electric motor, an electric energy accumulator, and an active connection to at least one drivable axle, the method comprising the acts of:
operating the electric motor as a generator for generating electric energy for charging the electric energy accumulator in a recuperation mode; and
transmitting at least partly the generated electric energy to at least one electric heating resistor in order to convert the transmitted electric energy into heat.

2. The method according to claim 1, wherein the act of transmitting the electric energy is carried out when the electric energy accumulator can no longer store, wholly or partly, the electric energy generated in the recuperation mode.

3. The method according to claim 1, wherein the generated electric energy is transmitted to the at least one electric heating resistor as a function of a temperature in an area of the electric heating resistor.

4. The method according to claim 2, wherein the generated electric energy is transmitted to the at least one electric heating resistor as a function of a temperature in an area of the electric heating resistor.

5. The method according to claim 1, further comprising the act of utilizing the at least one electric heating resistor to heat at least one of: motor oil, transmission oil, water, a vehicle battery, an interior of the vehicle, and a catalytic converter of the vehicle.

6. The method according to claim 2, further comprising the act of utilizing the at least one electric heating resistor to heat at least one of: motor oil, transmission oil, water, a vehicle battery, an interior of the vehicle, and a catalytic converter of the vehicle.

7. The method according to claim 3, further comprising the act of utilizing the at least one electric heating resistor to heat at least one of: motor oil, transmission oil, water, a vehicle battery, an interior of the vehicle, and a catalytic converter of the vehicle.

8. The method according to claim 1, wherein the vehicle includes a plurality of electric heating resistors, the method further comprising the act of transmitting the generated electric energy to the plurality of electric heating resistors in accordance with varying priorities.

9. The method according to claim 3, wherein the vehicle includes a plurality of electric heating resistors, the method further comprising the act of transmitting the generated electric energy to the plurality of electric heating resistors in accordance with varying priorities.

10. The method according to claim 5, wherein the vehicle includes a plurality of electric heating resistors, the method further comprising the act of transmitting the generated electric energy to the plurality of electric heating resistors in accordance with varying priorities.

11. A drivetrain for motor vehicle, comprising:
an electric motor;
an electric energy accumulator, wherein the drivetrain is actively coupled to at least one drivable axle; and
a control unit and at least one electric heating resistor; and
wherein the control unit is operatively configured to transmit generated electric energy to the at least one electric heating resistor in order to convert the transmitted electric energy into heat in a recuperation mode when the electric motor is operated as a generator for generating electric energy for use in charging the electric energy accumulator.

12. The drivetrain according to claim 11, wherein a plurality of electric heating resistors are provided, said resistors having at least one of different and controllable resistance values.

13. The drivetrain according to claim 11, wherein the at least one electric heating resistor is operatively located in at least one of: an engine area, transmission area, battery area, air supply system area for an interior of the vehicle, and an area of a vehicle catalytic converter.

14. The drivetrain according to claim 12, wherein the at least one electric heating resistor is operatively located in at least one of: an engine area, transmission area, battery area, air supply system area for an interior of the vehicle, and an area of a vehicle catalytic converter.

15. The drivetrain according to claim 11, further comprising a temperature sensor operatively configured to monitor a temperature in an area of the at least one electric heating resistor.

16. The drivetrain according to claim 13, further comprising a temperature sensor operatively configured to monitor a temperature in an area of the at least one electric heating resistor.

17. The drivetrain according to claim 11, wherein the drivetrain is provided in a hybrid vehicle.
